(19) United States
(12) Patent Application Publication
(10) Pub. No.: US 2020/0337949 A1
(43) Pub. Date: Oct. 29, 2020

(54) Pacifier Holder

(71) Applicants: Melissa Leigh Rosen, Beaconsfield (CA); Melissa Buck, Montreal (CA)

(72) Inventors: Melissa Leigh Rosen, Beaconsfield (CA); Melissa Buck, Montreal (CA)

(21) Appl. No.: 16/396,543

(22) Filed: Apr. 26, 2019

(51) Int. Cl. A61J 17/00

(52) U.S. Cl. CPC A61J 17/007; A61J 17/008

(57) ABSTRACT

A pacifier holder is comprised of a weighted body that sits on a surface, with an elongated appendage or appendages, and protrusion or protrusions, that extend from a body, in any direction, and serve as a pacifier retaining structure on which the handle of a pacifier or pacifiers, or other groove in a pacifier or pacifiers, can be easily hooked or rested upon, to store a pacifier or pacifiers in a hygienic manner, suspended above a surface, when not in use.

### FIELD OF THE INVENTION

The present invention relates generally to a pacifier holder which is a consumer product directed to parents and caregivers of infants, toddlers and children as a mean to store a pacifier in a hygienic manner, suspended above a surface, when not being used by an infant, toddler or child.

### BACKGROUND OF THE INVENTION

In its most common design, a pacifier is an artificial nipple connected to a mouth shield and handle, designed for babies, infants and children to suck on for comfort. A nipple goes directly in a user's mouth, therefore hygiene and cleanliness is important.

The conventional pacifier storage device is a pacifier pod or container. Alternatively, a pacifier holder can be used by parents and caregivers of infants, toddlers and children as a mean to store a pacifier, when not in the mouth of an infant, toddler or child, by hanging the pacifier handle on an elongated appendage or protrusion. An elongated appendage or protrusion keeps a pacifier suspended above a surface, ensuring the nipple does not come in contact with or become contaminated by surface dirt and germs. A pacifier is easily stored and easily retrieved by a parent or caregiver using one hand, whereas a pacifier pod generally requires the use of two hands. Furthermore, a pacifier holder provides a more hygienic storage solution since the pacifier nipple never touches a surface, whereas when placed in a pacifier pod or container, a nipple touches the containing walls of the pod. Lastly, pacifiers are wet after being extracted from a mouth and a pacifier pod or container provides a humid, moist environment which yields optimal conditions for germs and bacteria to grow. The pacifier holder overcomes this weakness since the pacifier is suspended in the air which allows the nipple to dry.

### SUMMARY

The present invention is a pacifier holder which is comprised of a weighted body that sits on a surface, with an elongated appendage or appendages, and protrusion or protrusions, that extend from a body, in any direction, and serve as a pacifier retaining structure on which a handle of a pacifier or pacifiers, or other groove in a pacifier or pacifiers, can be easily hooked or rested upon, to store a pacifier or pacifiers in a hygienic manner, suspended above a surface, when not in use.

The present invention is a pacifier holder which is comprised of a weighted body that sits on a surface. The body is given weight by particulate matter, nano material or other substance that when concentrated in the base, allows a pacifier holder to sustain added weight on its appendages and protrusions and remain sturdily upright.

The present invention could embody various designs, shapes, sizes and dimensions.

The body of a pacifier holder or base of a pacifier holder has appendages and protrusions so that a handle of a pacifier or other groove in a pacifier can be hooked or rested upon, to hold the pacifier in a manner so that a pacifier nipple does not come in contact with any surface and is suspended in the air. This is achieved by changing the height of the body or angle of the appendage and protrusion or both based on the various designs, shapes, sizes and dimensions embodied by the invention.

In some embodiments the present invention has one appendage or protrusion to hang a pacifier or pacifiers or multiple appendages or protrusions to hang a pacifier or pacifiers. Furthermore, in some embodiments the present invention has one appendage and no protrusions; or many appendages and no protrusions; or no appendages and one protrusion; or no appendages and many protrusions.

The slope of the appendages and protrusions of the present invention have angles that vary from 0° to 360°. The slope of the body of the present invention has angles that vary from 0° to 360°.

In some embodiments the present invention holds one pacifier or many pacifiers.

The present invention is formed of plastic, metal, silicone, rubber, porcelain, ceramic or other material or combination of materials. In some embodiments the present invention is formed of one single type of material or multiple different types of materials.

In some embodiments the present invention is constructed of a material that causes the invention to stick, suction or hold securely to a surface or has an added mechanism that causes the invention to stick, suction or hold securely to a surface.

In some embodiments the present invention is painted or printed on but is not required to be painted or printed on.

### BRIEF DESCRIPTION OF THE DRAWINGS

Many aspects of the disclosure can be better understood with reference to the following drawings. The components in the drawings are not drawn to scale. Furthermore, the present invention is not always embodied as an elephant, the pacifier holder may take various designs, forms, shapes and sizes. Emphasis should instead be placed on the illustrated principles, components and functions of the present disclosure.

FIG. 1 is a front view of a pacifier holder sitting on a surface constructed and arranged such that a weighted body sits on a surface, with an elongated appendage or appendages, and protrusion or protrusions, that extend from the body, in any direction, and serve as a pacifier retaining structure on which a handle of a pacifier or pacifiers, or other groove in the pacifier or pacifiers, can be easily hooked or rested upon, to store a pacifier or pacifiers in a hygienic manner, suspended above a surface, when not in use.

FIG. 2 is a side view of the pacifier holder.

FIG. 3 is a side sectional side view of the pacifier holder to demonstrate the weighted body which allows the pacifier holder to sustain added weight on its appendages and protrusions and remain sturdily upright. The weight in the base of the pacifier holder is not a designated shape, it fills the body of the pacifier holder, however the weight is depicted as a rectangle for illustration purposes.

FIG. 4 is a top view of the pacifier holder.

FIG. 5 is a rear view of the pacifier holder.

FIG. 6 is a front view of the pacifier holder sitting on a surface with a pacifier suspended from an appendage.

FIG. 7 is a side view of the pacifier holder with a pacifier suspended from an appendage.

FIG. 8 is a top view of the pacifier holder with a pacifier suspended from an appendage.

FIG. 9 is a side sectional view of the pacifier holder with a pacifier suspended from an appendage. The weight in the base of the pacifier holder is not a designated shape, it fills the body of the pacifier holder, however the weight is depicted as a rectangle for illustration purposes.

### DETAILED DESCRIPTION OF THE INVENTION

Reference is now made in detail to the description of the invention as illustrated in the drawings. While one embodiment is described in connection with these drawings, there is no intent to limit the disclosure to the embodiment disclosed herein. On the contrary, the intent is to cover all alternative designs, forms, shapes, sizes, equivalents and modifications.

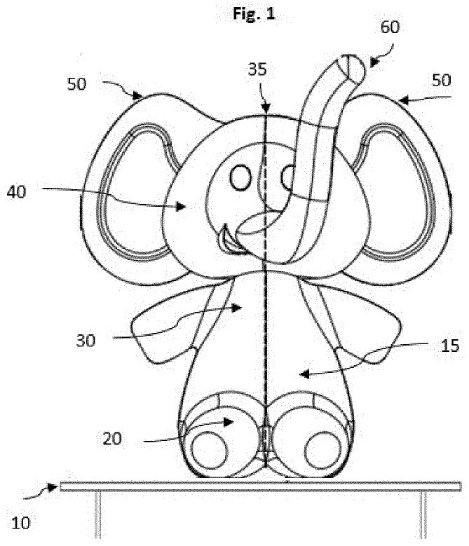

Turning now to the drawing, in which like reference characters indicate corresponding elements throughout the many views, FIG. 1 is a front view 15 of a pacifier holder sitting on a surface 10 constructed and arranged such that a weighted 70 body whereby a base 20 sits on a surface 10, with an elongated appendage or appendages 60, and protrusion 50 or protrusions 50, that extend from the body in any direction, and serve as a pacifier retaining structure on which a handle 55 of a pacifier or pacifiers, or other groove in a pacifier or pacifiers, when a handle 55 is absent, can be easily hooked or rested upon, to store a pacifier or pacifiers in a hygienic manner, suspended above a surface 10, when not in use.

Looking to FIG. 1, the base 20 of the present embodiment sits on a flat surface 10. However, given that the invention may take alternative designs, forms, shapes and sizes, the pacifier holder is not required to sit on a flat surface 10. Alternative designs and forms could sit on an uneven surface 10 or surfaces 10 with varying angle degrees including, but not limited to a 90° surface. Furthermore, the invention could be made of a material that causes the invention to stick, suction or hold securely to a surface 10 or have an added device that causes the invention to stick, suction or hold securely to a surface 10.

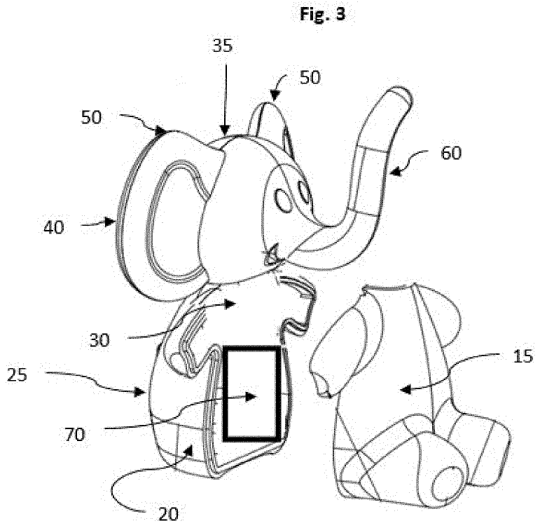

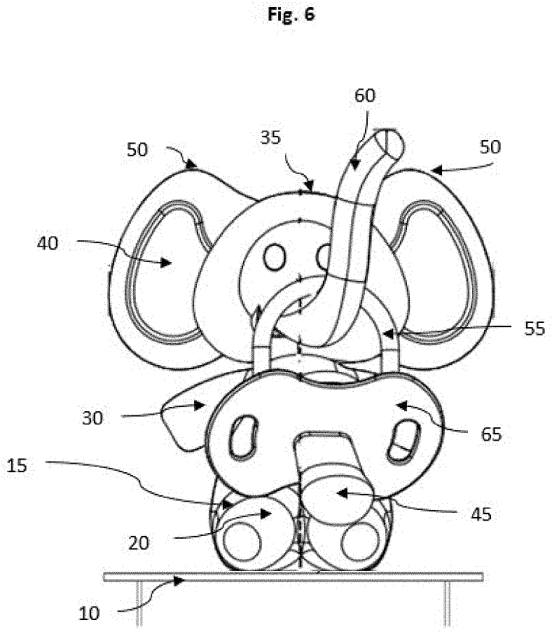

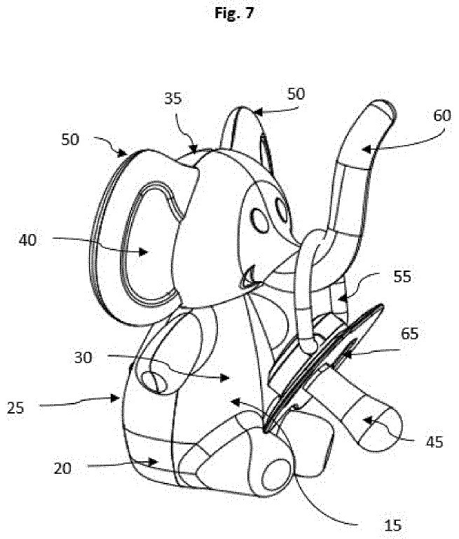

A weighted substance 70, as illustrated in FIG. 3, is found in the base 20 of the body but may also extend up through the mid region 30 and even the upper region 40 of the invention, as necessary. This allows the pacifier holder to sustain added weight on its appendages 60 and protrusions 50 and remain sturdily upright. The pacifier holder is designed to hold one pacifier, as demonstrated in FIGS. 6-9, or many pacifiers, therefore the weight 70 must be sufficient for the invention to remain upright when many pacifiers are placed on the appendages 60 and protrusions 50. The weighted substance 70 within the pacifier holder is not a designated shape, it fills the center of the pacifier holder, however the weight 70 in FIG. 3 is depicted as a rectangle for illustration purposes. The weighted substance 70 may be given mass by using particulate matter, nano material or other substance that when concentrated provides sufficient weight 70 to maintain the pacifier holder sturdily upright.

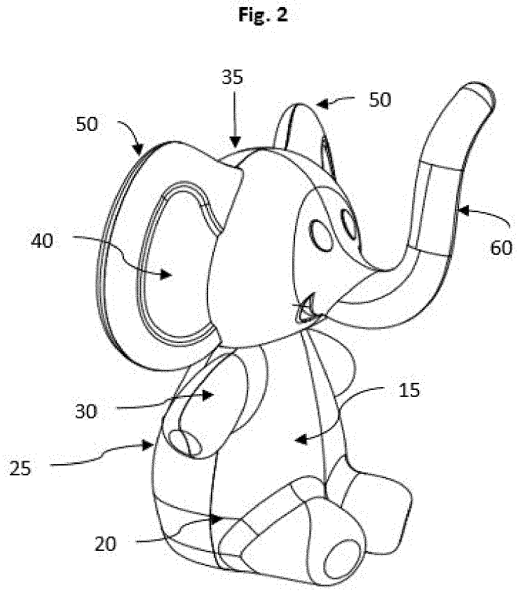

Looking to FIG. 2, the right-side view of the pacifier holder, there is one appendage 60. Given that the invention may take alternative designs, forms, shapes and sizes, the pacifier holder may have one appendage 60 or multiple appendages 60 in other embodiments of the invention.

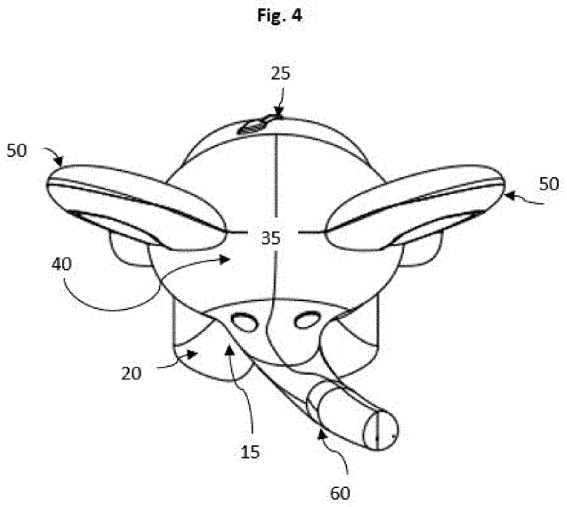

As illustrated in FIG. 4, the appendage 60 extends from the upper region 40 of the pacifier holder. Given that the invention may take alternative designs, forms, shapes and sizes, the appendage 60 or appendages 60 may extend from anywhere on the body including the base 20, mid region 30 or upper region 40 of the body or extend from multiple regions simultaneously in other embodiments of the invention. The height of the appendage 60 or appendages 60, along with the angle of the appendage 60 or appendages 60, ensures the pacifier nipple 45 is suspended above a surface 10 and does not come in contact with or become contaminated by surface 10 dirt and germs.

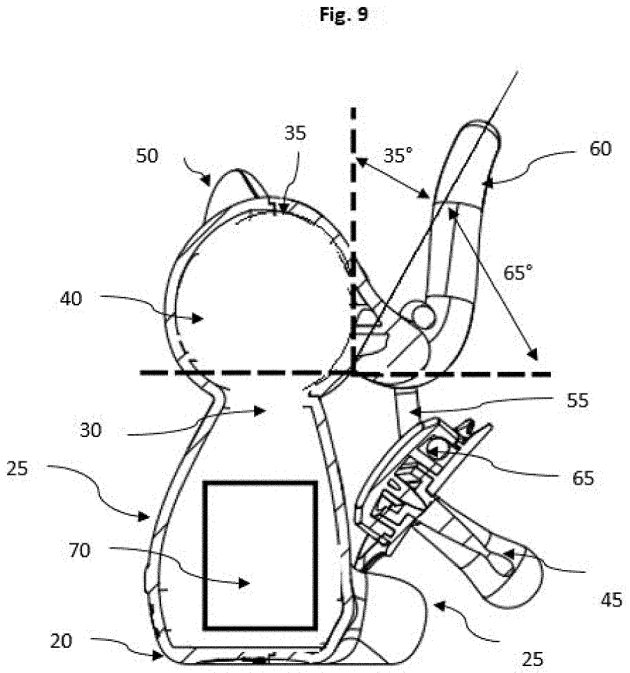

FIG. 9, a side sectional view of the pacifier holder holding a pacifier, demonstrates the 65° angle of the appendage 60. Given that the invention may take alternative designs, forms, shapes and sizes, the appendage 60 or appendages 60 may slope at angles ranging from 0° to 360° in other embodiments of the invention. The angle of the appendage 60 or appendages 60, along with the height of the appendage 60 or appendages 60, ensures the pacifier nipple 45 is suspended above a surface 10 and does not come in contact with or become contaminated by surface 10 dirt and germs.

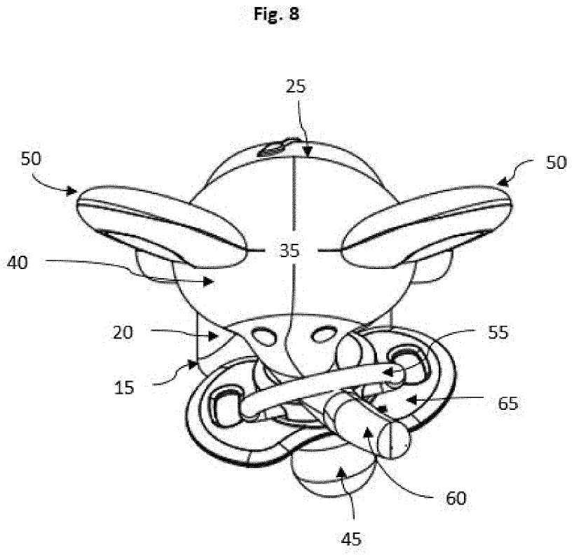

Looking to FIG. 8, a top 35 view of the pacifier holder holding a pacifier, the illustration depicts that the pacifier handle 55 can be easily threaded over the appendage 60 or removed from the appendage 60, using one hand or two fingers, which is important for parents and caregivers of infants, toddlers and children who often have their hands full when holding the infant, toddler or child.

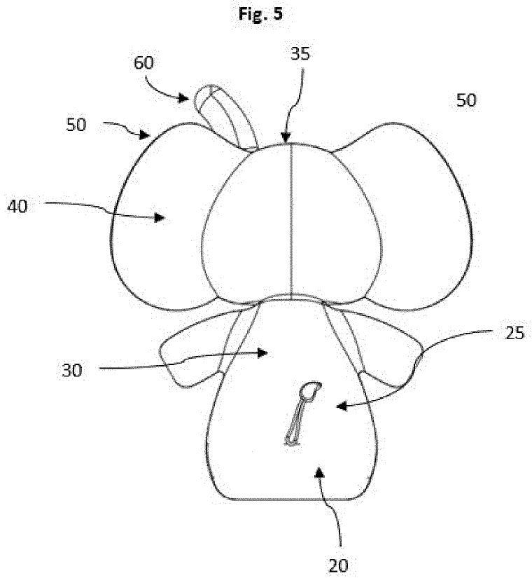

Referring to FIG. 5, the rear 25 view of the pacifier holder, there are two protrusions 50. Given that the invention may take alternative designs, forms, shapes and sizes, the pacifier holder may have one protrusion 50 or multiple protrusions 50 or no protrusions 50 in other embodiments of the invention.

As illustrated in FIG. 5, the protrusions 50 extend from the upper region 40 of the pacifier holder. Given that the invention may take alternative designs, forms, shapes and sizes, the protrusion 50 or protrusions 50 may extend from anywhere on the body including the base 20, mid region 30 or upper region 40 of the body or extend from multiple regions simultaneously in other embodiments of the invention.

The invention may have one appendage 60 and no protrusions 50. The invention may have many appendages 60 and no protrusions 50. The invention may have no appendages 60 and one protrusion 50. The invention may have no appendages 60 and many protrusions 50.

Looking to FIGS. 1-9, the present invention could be formed of plastic, metal, silicone, rubber, porcelain, ceramic or other material or combination of materials. The present invention could be formed of one single type of material or multiple different types of materials. Furthermore, the invention could be painted or printed on but is not required to be painted or printed on and could have a variety of textures and finishes.

Although exemplary embodiments have been shown and described, it will be clear to those of ordinary skill in the art that changes, modifications and alternations, as disclosed, may be made to the embodiment without departing from the nature and scope of the invention. For example the invention may take alternative designs, forms, shapes and sizes. The invention may have one appendage 60 or protrusion 50 or many appendages 60 or protrusions 50. The appendage 60 or protrusion 50 may extend from anywhere on the body including the base 20, middle region 30 or upper region 40 of the body or all regions or some regions. An appendage 60 or appendages 60 may slope at angles ranging from 0° to 360° in other embodiments of the invention. The weight 70 may be anywhere including the base 20 of the body or extend throughout the middle region 30 and upper region 40 to ensure the pacifier holder remains sturdily upright when weight is added to its appendages 60 or protrusions 50. The weight 70 may be given mass by particulate matter, nano material or other substance that when concentrated, allows the pacifier holder to sustain added weight on its appendages 60 and protrusions 50 and remain sturdily upright. The pacifier holder may hold one pacifier or many pacifiers. The present invention could be formed of plastic, metal, silicone, rubber, porcelain, ceramic or other material or combination of materials. To the extent that changes, modifications and alternations do not depart from the spirit of the invention, they are intended to be included within the scope of the disclosure.

Having fully described the invention in such clear and concise terms as to enable those skilled in the art to understand and practise the same, the invention claimed is:

1. A pacifier holder comprising:
a base that sits on a surface;
a body which sits on the base;
a weighted substance filling a center of a body;
an elongated appendage or appendages, and protrusion or protrusions;
the elongated appendage or appendages, and protrusion or protrusions that extend from the body or base, in any direction, serve as a pacifier retaining structure for receiving a handle of a pacifier or pacifiers, or other groove in the pacifier or pacifiers, thereby hooking the handle of the pacifier or pacifiers, to store a pacifier or pacifiers in a hygienic manner, suspended above a surface, when not in user, such that a nipple of the pacifier or pacifiers does not come into contact with the body of the pacifier holder or the elongated appendage or appendages, and protrusion or protrusions of the pacifier holder.

2. The pacifier holder of claim 1, has elongated appendages or protrusions which keep the pacifier suspended above a surface, ensuring a pacifier nipple does not come in contact with or become contaminated by surface dirt and germs, such that a nipple of the pacifier or pacifiers does not come into contact with the body of the pacifier holder or the elongated appendage or appendages, and protrusion or protrusions of the pacifier holder.

3. The pacifier holder of claim 1, is easily stored and easily retrieved by a parent or caregiver using one hand since the pacifier handle is simply hooked onto an appendage or protrusion and is not secured to the pacifier holder nor fastened to the pacifier holder in any manner.

4. The pacifier holder of claim 1 may take various shapes and sizes.

5. The pacifier holder of claim 1 sits on a surface but is not required to sit on a flat surface; alternative shapes and sizes may sit on uneven surfaces or surfaces with varying angle degrees, including but not limited to a 90° surface, which can include the pacifier holder serving as a wall hook for a pacifier or pacifiers.

6. The pacifier holder of claim 1 holds one pacifier or multiple pacifiers.

7. The pacifier holder of claim 1 has weighted substance filling the center of the body so that the pacifier holder can sustain added weight on its appendages and protrusions and remain sturdily upright when one pacifier is hung or multiple pacifiers are hung.

8. The pacifier holder of claim 1 has a weighted substance filling the center of the body which may be given mass by using particulate matter, nano material or other substance that when concentrated provides sufficient weight to maintain the pacifier holder sturdily upright when one pacifier is hung or multiple pacifiers are hung.

9. The pacifier holder of claim 1 may have one appendage or multiple appendages which may extend from the base, mid region or upper region of the body or extend from multiple regions simultaneously, providing support to hang a pacifier handle which allows the pacifier nipple to be suspended above a surface and does not come in contact with or become contaminated by surface dirt and germs, nor the pacifier holder itself, further ensuring pacifier hygiene.

10. The pacifier holder of claim 1 has an appendage or appendages which may slope at angles ranging from 0° to 360° providing the pacifier nipple is suspended above a surface and does not come in contact with or become contaminated by surface dirt and germs, nor the pacifier holder itself, further ensuring pacifier hygiene.

11. The pacifier holder of claim 1 may have one protrusion or multiple protrusions which may extend from the base, mid region or upper region of the body or extend from multiple regions simultaneously, providing support to hang a pacifier handle which allows the pacifier nipple is suspended above a surface and does not come in contact with or become contaminated by surface dirt and germs, nor the pacifier holder itself, further ensuring pacifier hygiene.

12. The pacifier holder of claim 1 may have one appendage and no protrusions; or many appendages and no protrusions; or no appendages and one protrusion; or no appendages and many protrusions; or any multiple combination thereof.

13. The pacifier holder of claim 1 could be formed of plastic, metal, silicone, rubber, porcelain, ceramic or other material or combination of materials that gives the pacifier holder a rigid structure to support an appendage or appendages and protrusion or protrusions which stores a pacifier or pacifiers in a hygienic manner, suspended above a surface, when not in user, such that the nipple of the pacifier or pacifiers does not come into contact with the body of the pacifier holder or the elongated appendage or appendages, and protrusion or protrusions of the pacifier holder.

14. The pacifier holder of claim 1 could be formed of one single type of material or multiple different types of materials.

15. The pacifier holder of claim 1 could be constructed of a material that causes the invention to stick, suction or hold securely to a surface or has an added mechanism that causes the invention to stick, suction or hold securely to a surface.

16. The pacifier holder of claim 1 allows the pacifier to be suspended or rested upon a protrusion or protrusions or appendage or appendages which allows a moist pacifier extracted from a baby's mouth to dry in open air, such that the nipple of the pacifier or pacifiers does not come into contact with the body of the pacifier holder or the elongated appendage or appendages, and protrusion or protrusions of the pacifier holder.
